(19) United States
(12) Patent Application Publication
(10) Pub. No.: US 2012/0207607 A1
(43) Pub. Date: Aug. 16, 2012

(54) INSERT FOR WIND TURBINE BLADE ROOT

(75) Inventor: Gabriel Mironov, Montreal (CA)

(73) Assignee: SUZHOU RED MAPLE WIND BLADE MOULD CO., LTD., Jiangsu (CN)

(21) Appl. No.: 13/497,970

(22) PCT Filed: Sep. 21, 2010
(86) PCT No.: PCT/CN10/01468

§ 371 Date: May 4, 2012

(30) Foreign Application Priority Data
Sep. 23, 2009 (CN) 200910175881.X
Jun. 24, 2010 (CN) 201010215195.3

(51) Int. Cl. F03D 11/00; B23P 15/04

(52) U.S. Cl. 416/204 R; 29/889.7

(57) ABSTRACT

An insert (10) for a wind turbine blade root has a wedge-like portion (16), the wedge-like portion (16) is elongate and extends between a distal end (14) and a proximal end (25) thereof. The wedge-like portion (16) has opposed major surfaces (24, 26) and a connection portion (12) for fitting the insert (10) to a mount, and increases in thickness between the opposed major surfaces (24, 26) in a direction from the distal end (14) to the proximal end (25). The connection portion (12) is integral with, and located at the proximal end (25) of the wedge-like portion (16). With this insert, the total weight of the assembled blade and raw material cost can be reduced considerably, and the manufacturing of the wind blade root including a plurality of such inserts is facilitated.

### TECHNICAL FIELD

The present invention/utility model relates to an insert for a wind turbine blade root, a wind blade root and a method of manufacturing a wind blade root

### BACKGROUND TO THE INVENTION/UTILITY MODEL

Throughout the history of wind turbine blade production, various efforts have been made to develop a robust, compact, and inexpensive root insert. It has been difficult to fix the composite structure of glass fiber/resin, wood fiber/resin, or carbon fiber/resin to the steel hub in an efficient and reliable way.

The root insert structures and installation methods used in the industry until now all fall into one of two categories.

The first category is represented by the following patent specifications: U.S. Pat. No. 7,163,378 B2, WO 2004/110862 A1/EP 1486415 A1, and U.S. Pat. No. 4,420,354 A.

In these specifications, a substantially circular metallic embed is adhesively bonded into the blade root by one means or another. The load transfer is accomplished by mobilizing shear in the bonding adhesive.

The limiting factor on the size of the blade root insert in the case of the known root insert structures and installation methods in the first category is the allowable shear stress on the bonding adhesive which joins the metallic insert to the composite blade root. Such bonding normally has a mediocre fatigue performance, and accordingly longer inserts are required to provide sufficient bonding area.

Also, in the case of the round inserts employed in the first category, it is difficult to pack the composite material layers tightly around the insert.

The main purpose of U.S. Pat. No. 7,163,378 B2 is to find introduce a more efficient method of filling the space around the insert so as to avoid the need to pack composite material layers manually into the triangular shaped gaps. However the suggested manufacturing method for filler pieces is complicated and costly.

WO 2004/110862 A1 discloses a star-shaped spacer device which may be used to help pack and arrange the composite layers around the inserts. However the spacer device must be left inside the blade root and cannot be removed after production is complete. This spacer device therefore adds an additional cost. Even with the spacer device present, it is still required to pack the layers manually with great effort on the inside surface of the blade root. This creates a possibility for air pockets and other quality defects to occur.

The second category in common use has never been patented as a fixing system at the blade root. However U.S. Pat. No. 7,186,086 B2 discloses a similar method to join together the parts of a two-part blade.

In this method, holes are first drilled into the blade structure in both axial and radial directions. Then a nut is captured in the laminate, and a stud is inserted in the axial direction. No structural adhesive bonding is required. The load transfer is accomplished by direct compressive bearing of the captured not on the laminate surface.

Such a root design, which consists of a stud and captured nut, is not at all efficient in terms of material consumption. Due to the stress concentration created by drilling holes in the blade, the laminate must be made much thicker than would otherwise be required.

### SUMMARY OF THE INVENTION/UTILITY MODEL

It is an aim of the present invention/utility model at least partially to overcome the disadvantages of the known wind blade root inserts discussed above.

It is a further aim of the present invention/utility model to provide a wind blade root insert which can provide a lower weight for the root insert and the wind blade root assembly.

It is a yet further aim of the present invention/utility model to provide a wind blade root insert which can provide a lower cost for the root insert and the wind blade root assembly.

It is a still further aim of the present invention/utility model to provide a wind blade root insert which can be used in an automated process for producing a wind blade root assembly.

Accordingly, in accordance with the present invention/utility model, there is provided An insert for a wind turbine blade root the insert having a wedge-like portion, the wedge-like portion being elongate and extending between a distal end and a proximal end thereof, the wedge-like portion having opposed major surfaces and increasing in thickness between the opposed major surfaces in a direction from the distal end to the proximal end, and a connection portion for fitting the insert to a mount, the connection portion being integral with, and located at the proximal end of, the wedge-like portion.

Optionally, the opposed major surfaces of the wedge-like portion taper outwardly away from each other. Further optionally, the opposed major surfaces of the wedge-like portion are each inclined at an acute angle to a central longitudinal plane extending through the wedge-like portion.

Optionally, a maximum thickness of the wedge-like portion is located at the proximal end of the wedge-like portion. Further optionally, the maximum thickness of the wedge-like portion is from 5 to 30 mm at the proximal end of the wedge-like portion.

Optionally, the opposed major surfaces of the wedge-like portion define a load transfer region of a double-scarf joint structure.

Optionally, the wedge-like portion has a ratio of length to maximum thickness of from 10:1 to 40:1.

Optionally, the wedge-like portion has a width of from 50 to 100 mm.

Optionally, the opposed major surfaces of the wedge-like portion are planar. Further optionally, the wedge-like portion has a substantially rectangular cross-section.

Optionally, the opposed major surfaces of the wedge-like portion are arcuate about a longitudinal axis of rotation. Further optionally, the wedge-like portion has a substantially arcuate cross-section.

Optionally, the wedge-like portion has an average thickness that is less than 30% of its total length, on an area weighted basis.

Optionally, the wedge-like portion has an average thickness that is less than 30% of its average width, on an area weighted basis.

Optionally, the opposed major surfaces of the wedge-like portion are at least partially covered with at least one interface layer of fibre-reinforced resin matrix composite lamination material.

Optionally, connection portion has an enlarged thickness relative to the thickness of the wedge-like portion. Further optionally, the connection portion has a threaded hole for engaging with a threaded stud of a mount.

Optionally, the connection portion is covered by a corrosion-resistant paint. Further optionally, the paint is one layer of epoxy based paint, followed by one layer of a polyurethane two component top coating.

The insert may optionally further comprise a neck transition between the wedge-like portion and the connection portion.

Optionally, the insert is made of forged steel. The opposed major surfaces of the wedge-like portion may be shot peened.

The present invention/utility model further provides a wind blade root incorporating an annular array of root inserts according to the present invention, the wind blade root having an annular end, the wedge-like portion of the insert being received within the annular end of the wind blade root, and the connection portion being external of the annular end of the wind blade root.

Optionally, the wedge-like portion is received in a complementary cavity in the annular end of the wind blade root.

Optionally, the wind blade root further comprises an intermediate composite material bonding layer between the opposed major surfaces of the wedge-like portion and the cavity.

Optionally, the opposed major surfaces of the wedge-like portion are bonded to the annular end of the wind blade root to define a load transfer region of a double-scarf joint structure.

Optionally, the annular end of the wind blade root and the wedge-like portion are structured so that, in the length direction along the length of the wedge-like portion, the thickness being considered at the thickest part of each of the annular end and the wedge-like portion, the annular end of the wind blade root and the wedge-like portion meet the criterion of Equation (1) below:

(Ac×Ec)/(As×Es)=0.5 to 1.5 [Equation (1)]

where Ac=cross-sectional area of the annular end, Ec=E Young's modulus of material of the annular end, As=cross-sectional area of wedge-like portion, Es=E Young's modulus of wedge-like portion in the longitudinal direction of the root.

Optionally, the adjacent wedge-like portions are separated by a spacing distance of up to 20 mm, typically from 5 to 10 mm.

The present invention/utility model yet further provides a method of manufacturing a wind blade root according to the present invention, the method including the steps of inserting the wedge-like portion of the root insert into a complementary cavity in the blade root and bonding the wedge-like portion of the root insert in the cavity.

With the present invention/utility model, the total weight of the assembled blade and raw material cost can be reduced considerably, which achieves a significant reduction in the blade cost. Because of its flattened shape, the present invention/utility model can greatly reduce the size of the spaces that would be difficult to fill between each insert. Therefore, it becomes possible by use of the present invention/utility model to automate the blade root production process.

### BRIEF DESCRIPTION OF THE ACCOMPANYING FIGURES

The present invention/utility model will be better understood with reference to the accompanying figures, in which:

FIG. 1 shows a perspective view, from one side and a proximal end, of a root insert for a wind turbine blade root according to an embodiment of the present invention/utility model;

FIG. 2 shows a perspective view, from an opposite side and a remote end, of the root insert of FIG. 1;

FIG. 3 shows a cross section of the insert of FIG. 1;

FIG. 4 shows another cross section of the insert of FIG. 1, taken perpendicularly to FIG. 3;

FIG. 5 shows an exploded perspective view of a wind turbine blade root incorporating a plurality of the inserts of FIG. 1;

FIG. 6 shows an end view of the wind turbine blade root of FIG. 5; and

FIG. 7 shows a cross section of the wind turbine blade root of FIG. 5.

### DETAILED DESCRIPTION OF THE PREFERRED EMBODIMENTS

Now, the present invention/utility model will be described with reference to the figures in detail which show an embodiment of a root insert in accordance with the present invention/utility model, and an embodiment a wind turbine blade root incorporating such a plurality of the root inserts of the present invention/utility model.

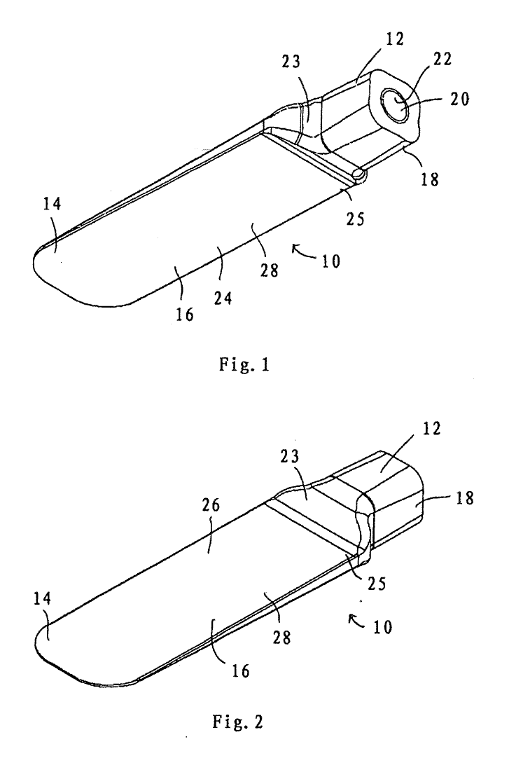

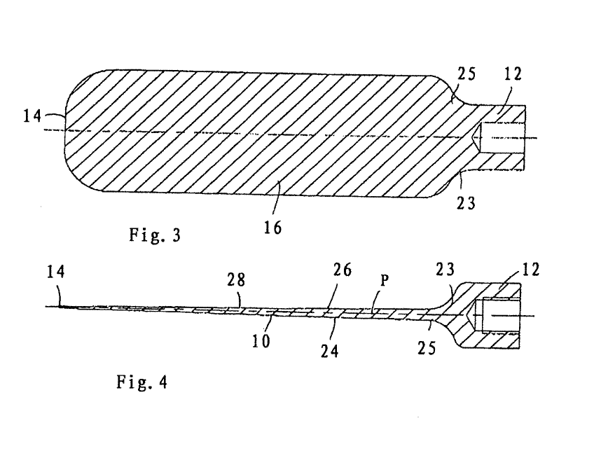

First, with reference to FIGS. 1 and 2 these drawings show respective perspective views, from opposite sides and opposite ends, of the root insert 10 for the wind turbine blade root. FIGS. 3 and 4 show respective cross-sections, which are mutually perpendicular, of the insert of FIG. 1.

The root insert 10 includes an enlarged connection portion 12 located at a proximal end 18 of the root insert 10 and a flattened wedge-like portion 16 located at a distal end 14 of the root insert 10. The enlarged connection portion 12 extends laterally from a longitudinal axis extending between the proximal and distal ends 18, 14 to provide a significant width in a direction perpendicular to the longitudinal axis. In the illustrated embodiment, the enlarged connection portion 12 has a substantially square cross-section, although other cross-sectional shapes may be employed.

The enlarged connection portion 12 has formed therein a longitudinally extending blind hole 20 for engagement with a stud bolt (not shown). The hole 20 has an internally threaded annular surface 22 for engagement with a corresponding thread of the stud bolt. The enlarged connection portion 12 and flattened wedge-like portion 16 are interconnected by a neck transition portion 23. The enlarged connection portion 12 has a sufficient width and sufficient length to enable the root insert 10 to support the load of the wind blade transmitted through the stud bolt without fatigue failure throughout the design life of the wind turbine blade. The hole 20 is longitudinally drilled into the enlarged connection portion 12 only a sufficient distance so that it either does not extend into the transition portion 23 or only does do for a minimal distance.

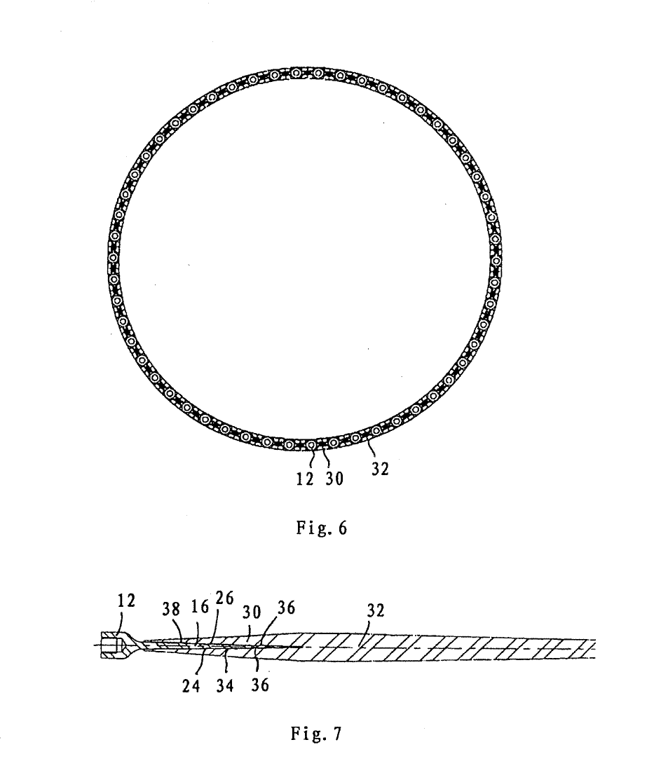

The enlarged connection portion 12 is greatly enlarged in the lateral direction perpendicular to the longitudinal axis as compared to the annular thickness of a wind blade root. Accordingly, when the root insert 10 is incorporated into a wind blade root, as shown in FIG. 6, the enlarged connection portion 12 protrudes outside the structural part of the blade root. Such a blade root may have a rectangular, rounded, or other annular shape. The enlarged connection portion 12 is designed such that the alternating fatigue stress remains at a low level, which is required because of the stress-concentrating corners of the machined hole 20 that must be provided for the stud bolt engagement.

The enlarged connection portion 12 necks down in thickness via the neck transition portion 22 into the wedge-like portion 16.

The wedge-like portion 16 has two opposed major surfaces 24, 26 tapering outwardly away from each other in a direction extending proximally from the distal end 14, the distal end 14 of the insert 10 also being the distal end of the wedge-like portion 16. At the distal end 14 the thickness of the wedge-like portion 16 is minimised and the major surfaces 24, 26 may substantially intersect. The major surfaces 24, 26 are each inclined at an acute angle to a central longitudinal plane P extending through the wedge-like portion 16. The maximum thickness of the wedge-like portion 16 is located at the proximal end 25 of the wedge-like portion 16 which is adjacent to the neck transition portion 22, prior to any significant increase in the rate of increase in the thickness of the insert 10. The two opposed surfaces 24, 26 define a load transfer region 28 in the tapered wedge-like portion 16 which is bonded to the composite material of the wind blade root to form a double-scarf joint structure when the wedge-like portion 16 is mounted and bonded within the wind blade root.

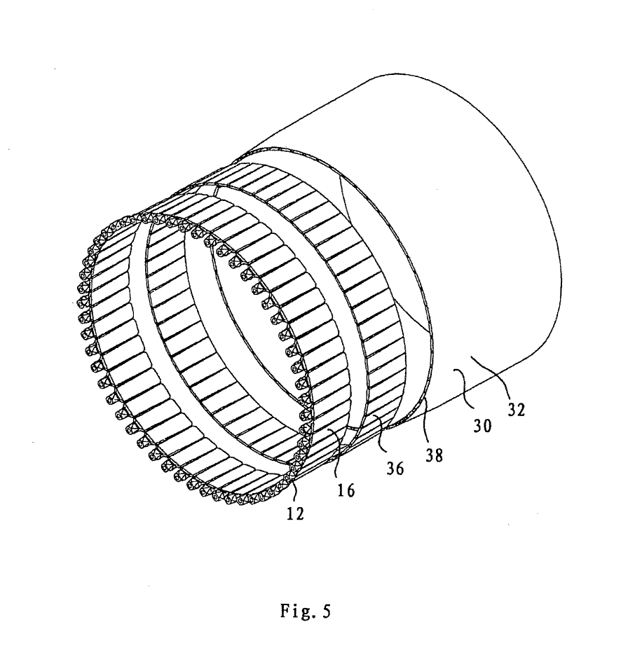

As shown in FIGS. 5 to 7, the wedge-like portion 16 is engaged inside the structural composite material 30 of the blade root 32 and transfers the alternating loads through shear force on the structural bond joint 34 extending over the surface area of the surfaces 24, 26 bonded to the composite material 30.

In this embodiment, a pre-applied composite layer 36, composed of fibre-reinforced resin matrix material, covers the surfaces 24, 26 of the wedge-like portion 16 to provide a secure bond, having a high shear strength, between the wedge-like portion 16 and the root 32.

In alternative embodiments, the root insert 10 may be incorporated into the blade root using other techniques. For example, the wedge-like portion 16 may be bonded directly by infusion with dry layers; may have a prepreg layer applied, then be bonded by resin infusion; may be incorporated into a complete prepreg root; may be bonded with adhesive into a prepared cavity; or may be inserted during a winding operation.

An annular array of root inserts 10 is disposed around the blade root 32, with the wedge-like portions 16 forming a double-scarf joint within the composite material 30. The composite material 30 extends circumferentially around the blade root 32, radially inwardly and radially outwardly of the wedge-like portions 16, which are each received within a respective cavity 38 located within the wind blade root 32. The composite material 30 is also located between adjacent wedge-like portions 16 so that no voids are present in the root structure comprised of the wedge-like portions 16 covered by the pre-applied composite layer 36 and bonded within the composite material 30.

The root insert 10 is composed of metal, typically steel and most typically forged steel. For example, the root insert 10 may be composed of medium carbon steel, or medium carbon steel containing boron, for example 1045 or 1060. Alternatively, the root insert 10 may be composed of Cr—Mo steel, such as 40CrMo or 4140.

The wedge-like portion 16 should be as wide as possible, allowing a minimum of gap between adjacent inserts (see FIGS. 4-5), in order to maximize the available bonding area. The width of the wedge-like portion 16 is limited by the distance between bolts on the hub. Preferably, there should be little empty space between adjacent root inserts 10, as that area would be lost for load transfer. Accordingly, the width of the wedge-like portion 16 is typically from 50 to 150 mm, those being the limiting values for distance between bolts on any practical pitch bearing. More typically, the width of the wedge-like portion 16 is from 80 to 100 mm, which is a common distance between bolts. The adjacent wedge-like portions 16 are typically separated by a spacing distance of up to 20 mm, more typically from 5 to 10 mm.

The thickness of the wedge-like portion 16 should be chosen in consideration of the fatigue strength of the material used therefor, which is typically a metal, most typically steel. The use of a higher fatigue strength material can result in a thinner wedge-like portion 16. It is desirable to make the wedge-like portion 16 as thin as possible, because in order to obtain a uniform shear stress over the shear-stress bearing surfaces of the wedge-like portion 16, that is, the major surfaces 24, 26 of the root insert 10 which are coupled to the wind blade root, the compliance of the entire blade root must be equalized over the axial length of the load transfer area of the root insert 10. Therefore, a higher stiffness of the root insert 10 would require more laminate to be provided in order to ensure compliance matching. The joint design is driven by the steel portion fatigue strength, with the composite material fatigue strength always far more than sufficient. Therefore, it becomes highly desirable to improve the fatigue strength of the insert 10, and consequently reduce its thickness.

Preferably, the wedge-like portion 16 of the insert 10 has an average thickness that is less than 30% of its total length, on an area weighted basis; and preferably, the wedge-like portion 16 of the insert 10 has an average thickness that is less than 30% of its average width, on an area weighted basis.

In this specification, the term “area weighted basis” means ‘divide the insert into n area segments, then multiply the area of each segment by the thickness of each segment, and divide the sum by the total area’. This is a parameter to define configurations for the relationship between the dimensions of the insert independent of the cross-sectional shape of the insert.

The thickness at the proximal end 25 of the load transfer region 28, which is the start of the load transfer region 28 when the insert 10 is incorporated into a wind blade root 32, the load transfer region 28 being the double-scarf tapered joint bonded to the composite material 30 of the blade root 32, is calculated on the basis of the fatigue loads and a S-N curve for the material of the insert 10, such as steel. The thickness depends on the design loads to be applied during the lifetime of the wind blade, but typically is from 5 to 30 mm in thickness. More typically, the thickness at the start of the load transfer region 28 is from 8 to 12 mm.

The length of the load transfer region 28 is limited by the allowable shear stress on the surfaces 24, 26 and the required thickness at the start of the load transfer region 28. Based on static and fatigue testing carried out by the Applicant, the ratio of length to maximum thickness should not be less than 10:1, and should not need to be more than 40:1. A preferred value is where failure of the metal portion, e.g. steel, and failure of the shear interface occur at a similar load level or where the metal portion fails only to a minor degree before the shear interface, allowing for some variability in bonding. Accordingly, a preferred range for the ratio of length to maximum thickness of the wedge-like portion 16 of the insert 10 is from 15:1 to 25:1. For example, if the wedge-like portion 16 of the insert 10 has a maximum thickness of 10 mm, and a length to maximum thickness ratio of 20:1, the length would be 200 mm in a typical embodiment.

The load transfer region 28 has a high aspect ratio, i.e. it is relatively thin but relatively wide. In the illustrated embodiment, the opposed surfaces 24, 26 defining the load transfer region 28 are planar. However, the opposed surfaces 24, 26 defining the load transfer region 28 do not have to be planar. For example, the surfaces 24, 26 may be curved about a longitudinal axis, to form an arcuate cross-section of the wedge-like portion 16 rather than a rectangular cross-section as in the illustrated embodiment. The arcuate cross-section may have a curvature having the same radius as that of the annulus of bolt holes 20 formed by the plurality of inserts 10 when mounted within a wind blade root 32. Alternatively, the surfaces 24, 26 may also provide the load transfer region 28 with another cross-sectional shape, such as a flattened triangle or flattened ellipse or other non-rectangular shape.

The load transfer region 28 is designed to meet certain criteria.

In particular, the section area at the thick proximal end must be sufficient to withstand the expected extreme loads and fatigue loads.

The section area of the composite part of the wind blade root 32 incorporating the root insert 10 is not dimensioned by strength, but rather by stiffness, in the case of using fiberglass laminate for the composite material of the wind blade root 32. Typically, the wind blade root 32 and the insert 10 are structured so that, in the length direction along the length of the wedge-like portion 16, the thickness being considered at the thickest part of each member, they meet the criterion of Equation (1) below:

(Ac×Ec)/(As×Es)=0.5 to 1.5 [Equation (1)]

where Ac=cross-sectional area of composite material of root, Ec=Young's modulus of composite material of root in the longitudinal direction of the root, As =cross-sectional area of wedge-like portion 16 (e.g. steel), Es=Young's modulus of wedge-like portion 16.

Such a relationship comes about by the consideration of the longitudinal stiffness of the wedge-like portion and the composite material of the root. The strain of a body under direct load is the applied force divided by the product of the Young's Modulus E×the cross sectional A. To reduce any strain discontinuity under load it is preferable that the combined EA value of the section=(Ac×Ec)+(As×Es) should be more or less constant, and varies by no more than +/−50%, preferably by no more than +/−25%, along the length of the load transfer region 28, in order to have a uniform distribution of shear stress along the length of the wedge-like portion 16.

Accordingly, the extensional stiffness reduction of the wedge-like portion 16 as it tapers down is compensated by a stiffness increase of the composite portion of the blade root 32.

The length of the wedge-like portion 16 of the insert 10 is dimensioned by the allowable taper ratio required in order to ensure failure of the metal (e.g. steel) of the insert 10 before bonding failure, both under extreme and fatigue loads. The Applicant has determined, based on experimental testing, that for extreme loading, the shear stress should not exceed 12.5N/mm², this giving a safety factor of 1.5 in order to ensure failure of the steel portion. Accordingly, if using steel having a yield point of 500 N/mm², which is a reasonable value for low alloy steel like 1045 in a tempered state, the taper ratio is 20:1 considering double shear on both the upper and lower surfaces 24, 26.

To improve the insert fatigue strength, it is advantageous to shot peen the root insert 10 heavily with steel balls in order to introduce residual compressive stress in the insert surface, in particular in the surfaces of the wedge-like portion 16. To prevent warping during the shot peening process, it is required to shot peen both sides of the root insert 10 simultaneously. This can be achieved by fixing the root inserts 10 vertically on a base plate and shooting both sides from two nozzles at the same time. After shot peening, it is desirable to sandblast the surfaces of the wedge-like portion 16 with fine sand, to give a smooth surface for improved adhesive bonding to the pre-applied composite layer 36. For example, an insert forged from steel can be shot peened to increase the tensile strength to a typical value of at least 600N/mm².

The yield point of the load transfer region 28 should ideally be as high as possible, since this would give more benefit from the shot peening and raise the fatigue limit.

Since there is a big difference of cost between medium carbon and Cr—Mo steels, the shot peening process can provide the advantage of achieving high enough yield strength for the root insert of the preferred embodiments using a lower cost medium carbon steel.

The exact geometry of the root insert is not particularly critical, as long as the root insert is free of sharp corners which would act as stress concentrating regions. It is required to avoid fatigue cracks emanating from the threads on the tubular enlarged section 12, particularly near the bottom of the threads, where the tube is already in a condition of full alternating stress, rather than a compressive prestress. The corresponding design to avoid such stress concentrations would be readily apparent to those skilled in the art.

After shot peening is finished, the surfaces 24, 26 of the wedge-like portion 16 should immediately be protected from corrosion. This is accomplished by immediately covering the surfaces 24, 26 with one interface layer of composite lamination, comprising a fibre-reinforced resin matrix material, as the pre-applied composite layer 36.

The portion of the insert 10 which protrudes from the blade root 32, for example the enlarged connection portion 12, should be protected from corrosion using a suitable paint. Most preferred is one layer of epoxy based paint, followed by one layer of a polyurethane two component top coating.

When the insert 10 is suitably processed, it can be installed into the blade root 32 as shown in FIG. 6, using a fixture plate (not shown) to obtain proper positioning of the annular array of inserts 10. The thin and tapered wedge-like portion 16 achieves the load transfer by shear force inside the structural part of the blade root 32. As shown in FIGS. 5 and 6, pre-applied composite material layers 36 are installed over and under the wedge-like portion 16 of the root insert 10 and then inserted into the mounting cavity 38 of the blade root 32 and bonded thereto, to make up the structural part 40 of the blade root 32. The actual cross-section shape of the mounting cavity 38 of the blade root 32 can be rectangular, triangular, oval, or another shape, but should be very much flattened with a high aspect ratio such that it is more or less similar to a strip-like shape, in order to cooperate with the strip-like shape of the wedge-like portion 16 of the insert 10.

By use of the insert of the present invention/utility model, the total weight of the assembled blade and raw material cost can be reduced considerably. For example, by using the insert of the present invention/utility model to replace a stud and captured nut system on a blade of 40.3 m length, intended for a 1.5 MW wind turbine, it was possible to achieve a weight reduction of over 200 kg.

The number of root inserts 10 provided in the blade root 32 tends to depend on the pitch bearing design of the wind turbine blade. Typically, there are not less than 50 root inserts for a 1.5 MW wind blade for a 1.5 MW wind turbine, and more for larger blades. A typical configuration is an insert width of 100 mm, and an insert spacing on Bolt Circle Diameter (BCD) of 109 mm, which is the situation for a 1800 mm BCD, 54 bolt, 1.5 MW blade using M30 bolts. If it is a larger blade, such as 2.5 MW, the BCD would typically be 2400 mm, allowing 70 bolts on similar spacing. However, for larger blades, it is possible to choose between using more bolts increasing the bolt diameter. It is also feasible to provide within the blade root two concentric rings of bolts and inserts, one within the other, which would double the available shear area between the inserts and the blade root.

Various modifications to the embodiments disclosed herein will be apparent to those skilled in the art.

1. An insert for a wind turbine blade root the insert having a wedge-like portion, the wedge-like portion being elongate and extending between a distal end and a proximal end thereof, the wedge-like portion having opposed major surfaces and increasing in thickness between the opposed major surfaces in a direction from the distal end to the proximal end, and a connection portion for fitting the insert to a mount, the connection portion being integral with, and located at the proximal end of, the wedge-like portion.

2. The insert as recited in claim 1, wherein the opposed major surfaces of the wedge-like portion taper outwardly away from each other.

3. The insert as recited in claim 2, wherein the opposed major surfaces of the wedge-like portion are each inclined at an acute angle to a central longitudinal plane extending through the wedge-like portion.

4. The insert as recited in claim 1, wherein a maximum thickness of the wedge-like portion is located at the proximal end of the wedge-like portion.

5. The insert as recited in claim 4, wherein the maximum thickness of the wedge-like portion is from 5 to 30 mm at the proximal end of the wedge-like portion.

6. The insert as recited in claim 1, wherein the opposed major surfaces of the wedge-like portion define a load transfer region of a double-scarf joint structure.

7. The insert as recited in claim 4, wherein the wedge-like portion has a ratio of length to maximum thickness of from 10:1 to 40:1.

8. The insert as recited in claim 7, wherein the wedge-like portion has a width of from 50 to 100 mm.

9. The insert as recited in claim 1, wherein the opposed major surfaces of the wedge-like portion are planar.

10. The insert as recited in claim 9, wherein the wedge-like portion has a substantially rectangular cross-section.

11. The insert as recited in claim 1, wherein the opposed major surfaces of the wedge-like portion are arcuate about a longitudinal axis of rotation.

12. The insert as recited in claim 11, wherein the wedge-like portion has a substantially arcuate cross-section.

13. The insert as recited in claim 1, wherein the wedge-like portion has an average thickness that is less than 30% of its total length, on an area weighted basis.

14. The insert as recited in claim 1, wherein the wedge-like portion has an average thickness that is less than 30% of its average width, on an area weighted basis.

15. The insert as recited in claim 1, wherein the opposed major surfaces of the wedge-like portion are at least partially covered with at least one interface layer of fibre-reinforced resin matrix composite lamination material.

16. The insert as recited in claim 1, wherein the connection portion has an enlarged thickness relative to the thickness of the wedge-like portion.

17. The insert as recited in claim 16, wherein the connection portion has a threaded hole for engaging with a threaded stud of a mount.

18. The insert as recited in claim 1, wherein the connection portion is covered by a corrosion-resistant paint.

19. The insert as recited in claim 18, wherein the paint is one layer of epoxy based paint, followed by one layer of a polyurethane two component top coating.

20. The insert as recited in claim 1, further comprising a neck transition between the wedge-like portion and the connection portion.

21. The insert as recited in claim 1, wherein the insert is made of forged steel.

22. The insert as recited in claim 1, wherein the opposed major surfaces of the wedge-like portion are shot peened.

23. A wind blade root incorporating an annular array of root inserts according to claim 1, the wind blade root having an annular end, the wedge-like portion of the insert being received within the annular end of the wind blade root, and the connection portion being external of the annular end of the wind blade root.

24. The wind blade root as recited in claim 23, wherein the wedge-like portion is received in a complementary cavity in the annular end of the wind blade root.

25. The wind blade root as recited in claim 23, further comprising an intermediate composite material bonding layer between the opposed major surfaces of the wedge-like portion and the cavity.

26. The wind blade root as recited in claim 23, wherein the opposed major surfaces of the wedge-like portion are bonded to the annular end of the wind blade root to define a load transfer region of a double-scarf joint structure.

27. The wind blade root as recited in claim 23, wherein, the annular end of the wind blade root and the wedge-like portion are structured so that, in the length direction along the length of the wedge-like portion, the thickness being considered at the thickest part of each of the annular end and the wedge-like portion, the annular end of the wind blade root and the wedge-like portion meet the criterion of Equation (1) below:
(Ac×Ec)/(As×Es)=0.5 to 1.5 [Equation (1)]
where Ac=cross-sectional area of the annular end, Ec=E Young's modulus of material of the annular end, As=cross-sectional area of wedge-like portion, Es=E Young's modulus of wedge-like portion.

28. The wind blade root as recited in claim 23, wherein the adjacent wedge-like portions are separated by a spacing distance of up to 20 mm, typically from 5 to 10 mm.

29. A method of manufacturing a wind blade root according to claim 24, the method including the steps of inserting the wedge-like portion of the root insert into a complementary cavity in the blade root and bonding the wedge-like portion of the root insert in the cavity.
